(19) United States
(12) Patent Application Publication
(10) Pub. No.: US 2025/0354592 A1
(43) Pub. Date: Nov. 20, 2025

(54) SYSTEMS FOR ABSORBING FLEXURAL WAVES ACTING UPON A STRUCTURE USING MONOPOLE AND DIPOLE RESONANCE AND A LEVER

(71) Applicants: Toyota Motor Engineering & Manufacturing North America, Inc., Plano, TX (US); Toyota Jidosha Kabushiki Kaisha, Toyota-shi (JP)

(72) Inventors: Xiaoshi Su, Ann Arbor, MI (US); Debasish Banerjee, Ann Arbor, MI (US); Miki Nakahara, Toyota-shi (JP); Tomohiro Miwa, Toyota-shi (JP)

(21) Appl. No.: 18/668,652

(22) Filed: May 20, 2024

(51) Int. Cl. F16F 7/108; G10K 11/172

(52) U.S. Cl. CPC F16F 7/108; G10K 11/172

(57) ABSTRACT

Disclosed are systems and devices for absorbing flexural waves using monopole and dipole resonance. In one example, a system includes a monopole scatterer coupled to a first side of a structure at a first location and a dipole scatterer coupled to a second side of the structure at a second location that at least partially overlaps the first location. At least one of the monopole scatterer and the dipole scatterer includes a lever.

### TECHNICAL FIELD

The present disclosure generally relates to systems and devices for absorbing flexural waves acting upon a structure.

### BACKGROUND

The background description provided is to present the context of the disclosure generally. Work of the inventors, to the extent it may be described in this background section, and aspects of the description that may not otherwise qualify as prior art at the time of filing, are neither expressly nor impliedly admitted as prior art against the present technology.

Flexural waves, sometimes called bending waves, deform the structure transversely as they propagate. Flexural waves are more complicated than compressional or shear waves and depend on material and geometric properties. Airborne noises can be created by flexural waves when an object comes into contact with a structure subjected to a flexural wave. Flexural vibrations of thin structures, such as beams, plates, and shells are the most common noise source caused by flexural waves.

Traditional sound absorption methods have been utilized to reduce noise caused by flexural waves, including installing sound absorbing materials that absorb radiated sound, applying damping materials to reduce vibration, and/or adding high-mass structures to prevent the passage of vibrations. However, these traditional sound absorption methods only reduce the airborne noise and do not significantly impact the flexural wave, which is the root cause of the airborne noise.

### SUMMARY

This section generally summarizes the disclosure and is not a comprehensive disclosure of its full scope or all its features.

In one embodiment, a system for absorbing a flexural wave acting upon a structure includes a monopole scatterer having an absorber coupled to the first side of the structure at a first location and a dipole scatterer having a base member coupled to the second side of the structure at a second location that at least partially overlaps the first location. In addition, the monopole scatterer and/or the dipole scatterer include a lever connected to a mass.

In another embodiment, a system for absorbing a flexural wave acting upon a structure includes a monopole scatterer having an absorber coupled to the first side of the structure at a first location and a dipole scatterer having a base member coupled to the second side of the structure at a second location that at least partially overlaps the first location. The monopole scatterer and the dipole scatterer may have substantially similar resonant frequencies. In addition, at least one of the monopole scatterer and the dipole scatterer includes a lever that includes a bar coupled to a mass and a support having a first end pivotably coupled to the bar at a pivot point and a second end coupled to the structure.

In yet another embodiment, a system includes a monopole scatterer coupled to the first side of a structure at a first location and a dipole scatterer coupled to the second side of the structure at a second location that at least partially overlaps the first location. At least one of the monopole scatterer and the dipole scatterer includes a lever.

Further areas of applicability and various methods of enhancing the disclosed technology will become apparent from the description provided. The description and specific examples in this summary are intended for illustration only and not to limit the scope of the present disclosure.

### BRIEF DESCRIPTION OF THE DRAWINGS

The accompanying drawings, which are incorporated in and constitute a part of the specification, illustrate various systems and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1 illustrates one example of a system for absorbing flexural waves acting on a structure having a monopole scatterer and a dipole scatterer that both include a lever.

FIG. 2 illustrates another example of a system for absorbing flexural waves acting on a structure, wherein the monopole scatterer includes a lever and the dipole scatterer does not include a lever.

FIG. 3 illustrates another example of a system for absorbing flexural waves acting on a structure, wherein the monopole scatterer does not include a lever and the dipole scatterer does include a lever.

FIGS. 4 and 5 illustrate the performance characteristics of a system for absorbing flexural waves wherein at least one of the monopole scatterer and the dipole scatterer include a lever.

### DETAILED DESCRIPTION

Described are systems utilizing scatterers, sometimes referred to as resonators, for absorbing flexural waves acting on a structure. Systems that utilize the scatterer may be able to absorb vibrations, including flexural waves in a beam or plate-like structure. In one example, the system utilizes two scatterers-a dipole scatterer with a dipolar resonance and a monopole scatterer with a monopolar resonance. At least one of the scatterers includes a lever to amplify the performance of the scatterer, especially when utilizing a smaller mass. By so doing, the overall weight of the scatterer can be reduced without impacting performance. The dipole scatterer and the monopole scatterer are generally located at the same location along the structure such that they overlap with each other. Each of the scatterers is capable of absorbing 50% of the energy carried by the incident waves. When both are attached to the same location of the structure, the absorption adds up to 100%.

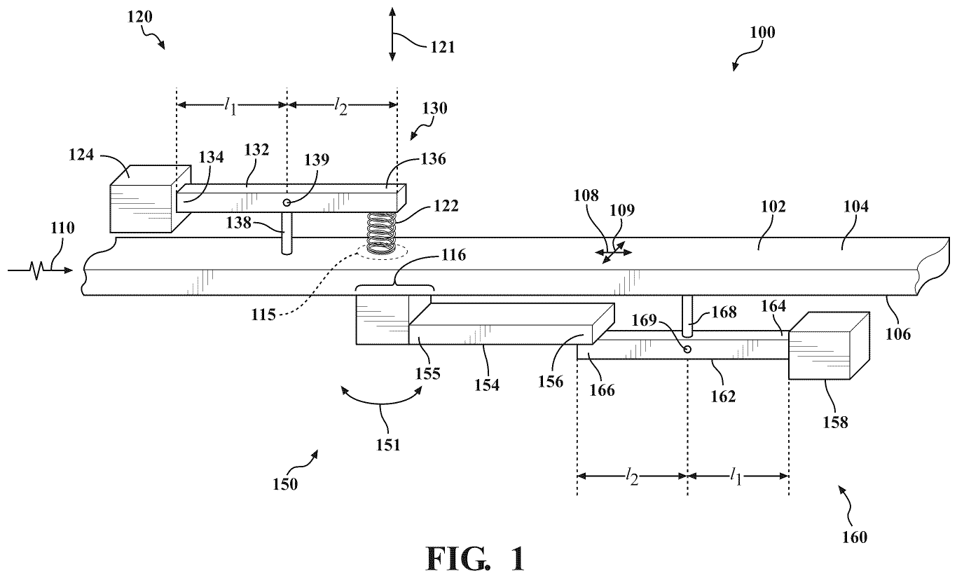

FIG. 1 illustrates a system 100 capable of absorbing a flexural wave acting upon a structure 102. In this example, the structure 102 is a beam, but the structure 102 may take any one of a number of different forms, such as plate-like structures. Here, the structure 102 has a top side 104 and a bottom side 106. As a structure 102 is a beam, the beam has a width 108 and a length 109. The length 109 is the longer dimension of the structure 102, while the width 108 is the shorter dimension. The structure 102 can be made out of any type of material but is generally made of a rigid or semi-rigid material.

The system 100 includes a monopole scatterer 120 and a dipole scatterer 150. Generally, at least portions of the monopole scatterer 120 and portions of the dipole scatterer 150 are attached to the structure at a first location 115 and a second location 116, respectively. In particular and as will be described in greater detail later in this description, an absorber 122 of the monopole scatterer 120 is connected to the first location 115, and a base member 152 of the dipole scatterer 150 is attached to the second location 116. Generally, the first location 115 and the second location 116 are located at opposing sides of the structure 102 and overlap with one another, at least partially. In other words, the first location 115 and the second location 116 are located on opposite sides of the structure 102 at the same location along the length 109 of the structure 102. As such, the base member 152 is attached to the structure 102 at the second location 116, which generally opposes and/or overlaps the first location 115, where the absorber 122 is located. As such, the origin of the dipole resonance (indicated by the left and right direction 151) created by the dipole scatterer 150 originates at the same location along the length 109 of the structure 102 as the origin of the monopole resonance (indicated by the up-and-down direction 121) created by the monopole scatterer 120.

While it is shown that the monopole scatterer 120 and the dipole scatterer 150 are located on opposite sides of the structure 102, it may be possible to connect the monopole scatterer 120 and the dipole scatterer 150 to the structure 102 at the same location on the same side of the structure 102. Regardless of the arrangement, the monopole scatterer 120 generally resonates in an up-and-down direction 121 with respect to the top side 104 of the structure 102. In contrast, the dipole scatterer 150 generally resonates in a left and right direction 151.

In this example, the monopole scatterer 120 includes an absorber 122, a mass 124, and a lever 130. The absorber 122 may be attached to the structure 102 at the first location 115 and may provide both spring and dampening properties, typically found in a mass-spring-damper model. As such, the absorber 122 can absorb, store, and expend energy, as well as dissipate energy. In one example, the absorber 122 may be a springlike structure made of a flexible material. However, it should be understood that any appropriate structure or materials may be utilized.

Also attached to the absorber 122 may be the lever 130. The lever 130 includes a bar 132 and a support 138 that is pivotably attached to the bar 132 at a pivot point 139. An opposing end of the support 138 may be attached to the top side 104 of the structure 102 so as to elevate the bar 132 away from the structure 102 to allow the bar 132 to rotate about the pivot point 139. A first portion 134 of the bar 132 may be attached to the mass 124, while a second portion 136 of the bar 132 may be attached to the absorber 122. The first portion 134 and the second portion 136 of the bar 132 may be divided at the pivot point 139. Generally, the bar 132 is made out of a lightweight and stiff material, such as carbon fiber, but other suitable materials may also be utilized.

As such, when a flexural wave 110 acts upon the structure 102, the flexural wave 110 causes an up-and-down movement of the mass 124 and the absorber 122. The mass 124 generally rotates about the axis defined by the pivot point 139. The mass 124 may be made of a rigid material, such as steel, iron, aluminum, ceramics, plastics, etc. However, the mass 124 may be made of any suitable material that allows the mass 124 to act as a mass in a mass-spring-damper system.

This type of arrangement of the monopole scatterer 120, wherein the lever 130 is used, allows the mass 124 to be effectively amplified without adding additional weight. The amplification of the mass 124 can be expressed as (I₁/I₂)², wherein I₁ is the distance of the bar 132 between the pivot point 139 and the mass 124, and I₂ is the distance of the bar 132 between the pivot point 139 and the absorber 122. As such, the overall weight of the monopole scatterer 120 can be reduced by utilizing the lever 130, as shown, because the use of the lever 130 essentially amplifies the effects of the mass 124 on the absorber 122.

The mass reduction properties utilizing a lever can also be incorporated within the dipole scatterer 150. As mentioned before, dipole scatterer 150 generally resonates in a left and right direction 151. In this example, the dipole scatterer 150 includes a base member 152, a bending spring 154, a mass 158, and a lever 160. The base member 152 is attached to the bottom side 106 of the structure 102 at the second location 116. As stated previously, the second location 116 may at least partially overlap the first location 115. The base member 152 may be connected to the structure 102 using any appropriate methodology. Generally, the base member 152 may be in the form of a cube and is generally made of a lightweight, stiff material. However, it should be understood that the base member 152 may take any one of a number of different shapes and/or be made out of a number of different materials. In addition, the base member 152 may be a unitary structure formed along with one or more other components making up the dipole scatterer 150.

Attached to the base member 152 is the bending spring 154. Moreover, a first end 155 of the bending spring 154 may be attached to the base member 152. The bending spring 154 may be a rectangular structure that generally has a length that extends parallel to the length of the structure 102. The bending spring 154 may utilize a low-stiffness material. Some substantial damping (typically between 5% to 15%) may be needed in the bending spring 154. The rotation of the bending spring 154 exerts a moment on the dipole scatterer 150 so that it vibrates in the left and right direction 151 along the structure 102.

The dipole scatterer also includes a mass 158 that is attached to the bending spring 154 by the lever 160. The mass 158 may be made of a rigid material, such as steel, iron, aluminum, ceramics, plastics, etc. However, the mass 158 may be made of any suitable material that allows the mass 158 to act as a mass in a mass-spring-damper system.

As to the lever 160, the lever 160 includes a bar 162 and a support 168 that is pivotably attached to the bar 162 at a pivot point 169. An opposing end of the support 138 may be attached to the bottom side 106 of the structure 102 so as to elevate the bar 162 away from the structure 102 to allow the bar 162 to rotate about the pivot point 169.

A first portion 164 of the bar 162 may be attached to the mass 158, while a second portion 166 of the bar 162 may be attached to a second end 156 of the bending spring 154. The first portion 164 and the second portion 166 of the bar 162 may be divided at the pivot point 169. Generally, the bar 132 is made out of a lightweight and stiff material, such as carbon fiber, but other suitable materials may also be utilized.

As with the monopole scatterer 120, the lever 160 essentially amplifies the effects of the mass 158 without adding additional weight. Like before, the amplification of the mass 158 can be expressed as (I₁/I₂)², wherein I₁ is the distance of the bar 162 between the pivot point 169 and the mass 158, and I₂ is the distance of the bar 162 between the pivot point 169 and the bending spring 154. As such, the overall weight of the dipole scatterer 150 can be reduced by utilizing the lever 160, as shown, because the use of the lever 160 essentially amplifies the effects of the mass 158 on the base member 152.

The resonant frequencies of the monopole scatterer 120 and the dipole scatterer 150 may be substantially equal, i.e., within 20% of each other. Additionally, the frequency of the flexural wave 110 acting upon the structure 102 is also substantially equal, i.e., within 20%, of the resonant frequencies of the monopole scatterer 120 and the dipole scatterer 150. Each of the scatterers is capable of absorbing 50% of the energy carried by the incident waves. When both are attached to the same location of the structure, the absorption adds up to 100%.

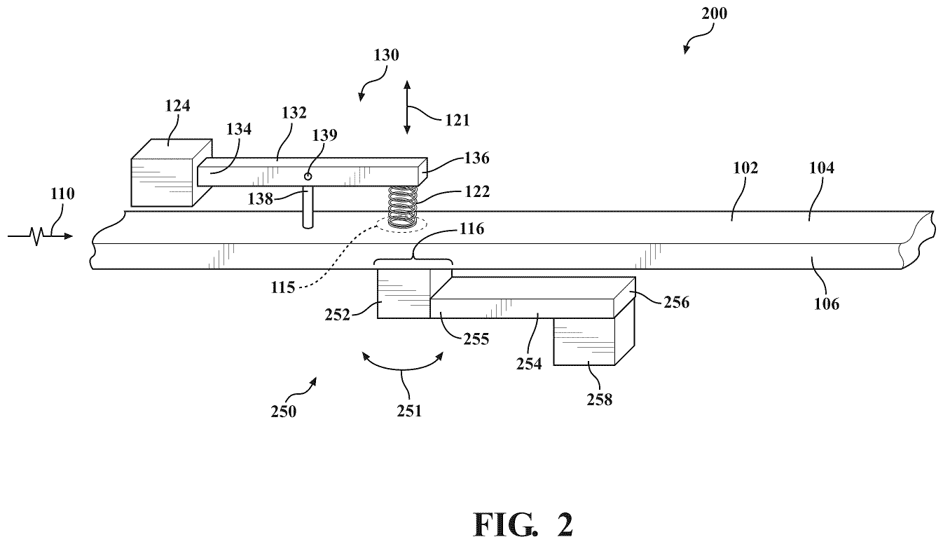

FIG. 2 illustrates another example of a system 200 that is capable of absorbing flexural waves acting upon the structure 102. Like reference numerals have been used to refer to like elements and, unless otherwise noted, are equally applicable to the system 200 and will not be described again. The system 200 differs from that of the system 100 of FIG. 1 in that the system 200 has replaced the dipole scatterer 150, which utilizes the lever 160, with a dipole scatterer 250 that does not utilize a lever. Like the dipole scatterer 150, the dipole scatterer 250 generally resonates in a left and right direction 251.

Here, the dipole scatterer 250 includes a base member 252 that may be in the shape of a cube that is attached to the second location 116 on the bottom side 106 of the structure 102. It should be understood that the base member 252 may take any one of a number of different shapes and/or made out of a number of different materials. Like before, the second location 116 generally overlaps the first location 115. Here, also illustrated, is a bending spring 254 that includes a first end 255 attached to the base member 252 and a second end 256 attached to a mass 258. The bending spring 254, like the bending spring 154, may be a rectangular structure that generally has a length that extends parallel to the length of the structure 102. The bending spring 254 may utilize a low-stiffness material. Some substantial damping (typically between 5% to 15%) may be needed in the bending spring 254. The rotation of the bending spring 254 exerts a moment on the dipole scatterer 250 so that it vibrates in the left and right direction 251 along the structure 102. The mass 258 may be made of a rigid material, such as steel, iron, aluminum, ceramics, plastics, etc., or any suitable material that allows the mass 258 to act as a mass in a mass-spring-damper system.

Because the dipole scatterer 250 does not utilize a lever, the dipole scatterer 250 does not amplify the effects of the mass 258 upon the system. As such, the dipole scatterer 250 may be somewhat heavier than a dipole scatterer generally constructed along the lines described regarding the dipole scatterer 150. Nevertheless, in some cases, it may be preferable to have a system wherein the dipole scatterer 250 does not utilize a lever to amplify the effects of the mass 258.

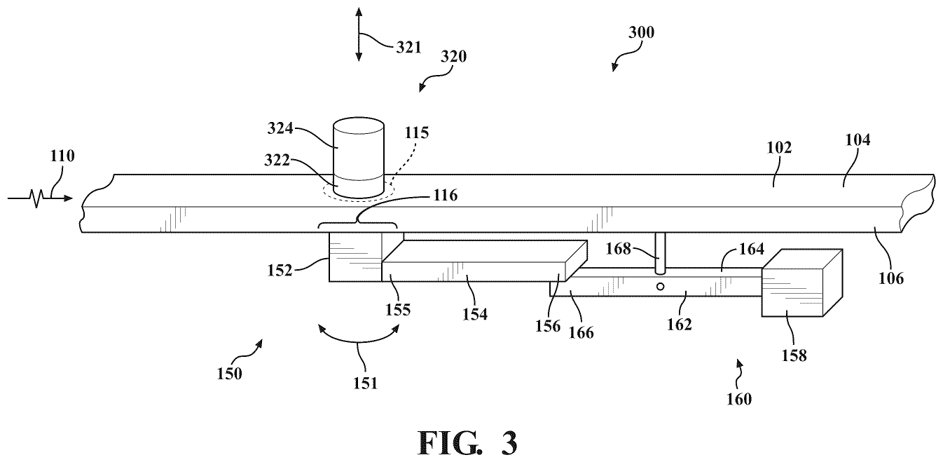

The opposite arrangement may also be true, wherein the dipole scatterer utilizes a lever and the monopole scatterer does not. Moreover, FIG. 3 illustrates a system 300 that is similar to the system 100 of FIG. 1 but has replaced the monopole scatterer 120, which utilizes the lever 130, with a monopole scatterer 320 that does not. Like before, like reference numerals have been utilized to refer to like elements and, unless otherwise noted, are equally applicable to the system 300 and will not be described again. It should be understood that the monopole scatterer 320 can take any one of a number of different forms and that this is just merely one example of the form it may take. Regardless of the arrangement, the monopole scatterer 320 generally resonates in an up-and-down direction 321.

Here, the monopole scatterer 320 includes a solid member 324 and a flexible member 322. Generally, the solid member 324 acts as a mass in a mass-spring-damper system and may be made of a rigid material, such as steel, iron, aluminum, ceramics, plastics, etc. However, the solid member 324 may be made of any suitable material that allows the solid member 324 to act as a mass in a mass-spring-damper system.

As to the flexible member 322, the flexible member 322 acts as a spring and damper in a mass-spring-damper system and may be made of a flexible material, such as rubber and soft plastics, such as thermoplastic elastomers, and/or thermoplastic polyurethane. However, the flexible member may be made of any suitable material that allows the flexible member 322 to act as a spring and damper in a mass-spring-damper system.

The solid member 324 may be attached to the flexible member 322 using adhesives. However, the solid member 324 may be attached to the flexible member 322 using a number of different methodologies, such as press-fitting, over-molding, crimping, and/or using retainers, such as screws. The flexible member 322 may be attached to the structure 102 at the first location 115 using similar methodologies, such as adhesives, press-fitting, over-molding, crimping, and/or using retainers, such as screws. When monopole scatterer 320 is attached to the structure 102, the flexible member 322 is located between the structure 102 and the solid member 324.

Like the monopole scatterer 120, the monopole scatterer 320 may have a resonant frequency substantially similar to the resonant frequency of the flexural wave 110 acting upon the structure 102 to which the monopole scatterer 320 is attached and/or the resonant frequency of the dipole scatterer 150. Since the monopole scatterer 320 is a spring-mass-damper system, the lumped mass M of the solid member 324 may be represented as M=ρAh₁, wherein ρ is the density of the material that makes up the solid member 324, A is the cross-sectional area of the monopole scatterer 320 is (in particular, the cross-sectional area of the solid member 324), and h₁ is the height of the solid member 324. Since the mass of the flexible member 322 may be negligible, the mass of the solid member 324 could be taken as the mass of the monopole scatterer 320.

The lumped stiffness of the monopole scatterer 320 may be represented as κ=EA/(βh₂), where E is the Young's modulus of the material that makes up the flexible member 322, A is the cross-sectional area of the monopole scatterer 320 (in particular, the cross-sectional area of the flexible member 322), and h₂ is the height of the flexible member 322. The damping property C of the material that makes up the flexible member 322 comes from the viscous damping in the material, which can be modeled as the imaginary part of Young's modulus.

As such, in this example, because the monopole scatterer 320 does not utilize a lever, the monopole scatterer 320 does not amplify the effects of the solid member 324 upon the system 300. As such, the monopole scatterer 320 may be somewhat heavier than a dipole scatterer generally constructed along the lines described regarding the monopole scatterer 120.

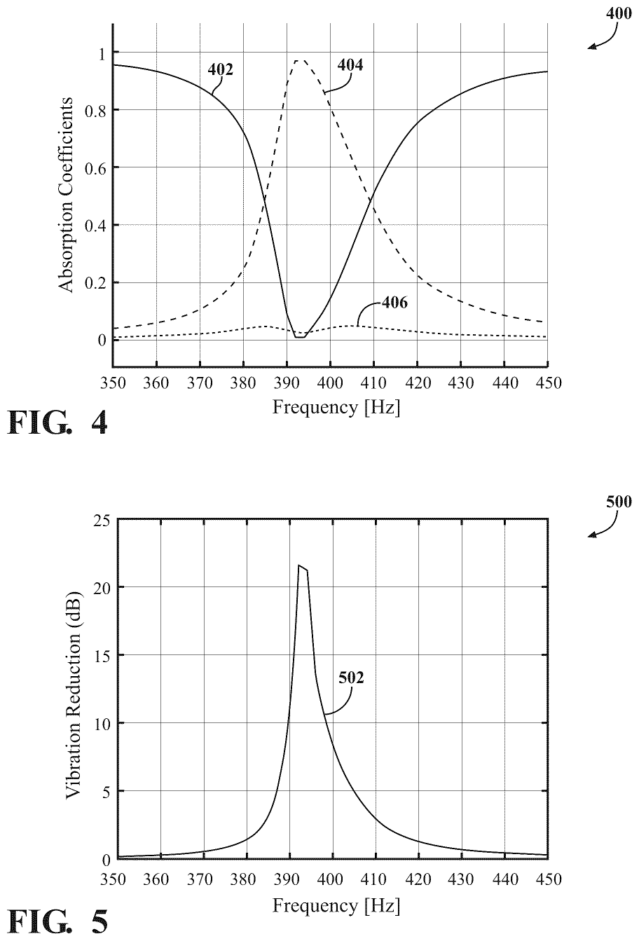

Referring to FIGS. 4 and 5, illustrated are the performance characteristics 400 and 500, respectively, of a system, such as the system 100, wherein at least one of the dipole and/or monopole scatterers utilizes a lever. In this example, the monopole scatterer 120 and the dipole scatterer 150 have resonant frequencies at approximately 395 Hz. As best shown in FIG. 4, the transmission 402 of the flexural wave 110 along the structure 102 is significantly reduced at approximately 395 Hz. Additionally, the absorption 404 of the flexural wave 110 along the structure 102 is significantly maximized at the same frequency. Notably, the reflection 406 of the flexural wave 110 along the structure 102 is not impacted. Further still, as shown in FIG. 5, the vibration reduction 502 is significantly reduced by the system 100 at approximately 395 Hz.

The systems and devices described and illustrated in this description can achieve excellent absorption of flexural waves by utilizing a monopole scatterer and a dipole scatterer at the same location on the structure but also take advantage of a lever to reduce overall weight. As shown in FIGS. 4 and 5, each of the scatterers is capable of absorbing 50% of the energy carried by the incident waves. When both are attached to the same location of the structure, the absorption adds up to 100%.

The preceding description is illustrative and does not intend to limit the disclosure, application, or use. The phrase at least one of A, B, and C should be construed to mean a logical (A or B or C), using a non-exclusive logical “or.” Disclosure of ranges includes disclosure of all ranges and subdivided ranges within the entire range.

The headings (such as “Background” and “Summary”) and sub-headings used herein are intended only for the general organization of topics within the present disclosure and are not intended to limit the disclosure of the technology or any aspect thereof. The recitation of multiple embodiments with stated features is not intended to exclude other embodiments with additional features or other embodiments incorporating different combinations of the stated features.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an embodiment can or may comprise certain elements or features does not exclude other embodiments of the present technology that do not contain those elements or features.

The broad teachings of the present disclosure can be implemented in various forms. Therefore, while this disclosure includes particular examples, the true scope of the disclosure should not be so limited since other modifications will become apparent to the skilled practitioner upon a study of the specification and the following claims. Reference herein to one aspect or various aspects means that a particular feature, structure, or characteristic described in connection with an embodiment or particular system is included in at least one embodiment or aspect. The appearances of the phrase “in one aspect” (or variations thereof) do not necessarily refer to the same aspect or embodiment.

The foregoing description of the embodiments has been provided for purposes of illustration and description. It is not intended to be exhaustive or to limit the disclosure. Individual elements or features of a particular embodiment are generally not limited to that particular embodiment but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

What is claimed is:

1. A system for absorbing a flexural wave acting upon a structure comprising:
a monopole scatterer having an absorber coupled to a first side of the structure at a first location; and
a dipole scatterer coupled to a second side of the structure at a second location, wherein the first location at least partially overlaps the second location; and
at least one of the monopole scatterer and the dipole scatterer includes a lever connected to a mass.

2. The system of claim 1, wherein the monopole scatterer and the dipole scatterer have substantially similar resonant frequencies.

3. The system of claim 2, wherein a frequency of the flexural wave is substantially similar to resonant frequencies of the monopole scatterer and the dipole scatterer.

4. The system of claim 1, wherein the structure is a beam.

5. The system of claim 1, wherein the structure is a plate.

6. The system of claim 1, wherein the lever comprises:
a bar coupled to the mass; and
a support having a first end pivotably coupled to the bar at a pivot point and a second end coupled to the structure.

7. The system of claim 6, wherein the absorber of the monopole scatterer is coupled to the bar.

8. The system of claim 7, wherein the mass is coupled to a first portion of the bar and the absorber of the monopole scatterer is coupled to a second portion of the bar, the first portion and the second portion of the bar being divided at the pivot point of the bar.

9. The system of claim 6, wherein the dipole scatterer includes a bending spring attached to a base member that is coupled to the second side of the structure at the second location.

10. The system of claim 9, wherein the mass is coupled to a first portion of the bar and the bending spring is coupled to a second portion of the bar, the first portion and the second portion of the bar being divided at the pivot point of the bar.

11. A system for absorbing a flexural wave acting upon a structure comprising:
a monopole scatterer having an absorber coupled to a first side of the structure at a first location; and
a dipole scatterer having a base member coupled to a second side of the structure at a second location, wherein the first location at least partially overlaps the second location and the monopole scatterer and the dipole scatterer have substantially similar resonant frequencies,
wherein at least one of the monopole scatterer and the dipole scatterer includes a lever that includes a bar coupled to a mass and a support having a first end pivotably coupled to the bar at a pivot point and a second end coupled to the structure.

12. The system of claim 11, wherein a frequency of the flexural wave is substantially similar to resonant frequencies of the monopole scatterer and the dipole scatterer.

13. The system of claim 11, wherein the structure is a beam.

14. The system of claim 11, wherein the structure is a plate.

15. The system of claim 11, wherein the absorber of the monopole scatterer is coupled to the bar.

16. The system of claim 15, wherein the absorber of the monopole scatterer is coupled to a first portion of the bar and the mass is coupled to a second portion of the bar, the first portion and the second portion of the bar being divided at the pivot point of the bar.

17. The system of claim 11, wherein the dipole scatterer includes a bending spring attached to the base member.

18. The system of claim 17, wherein a first portion of the bar is connected to the bending spring and a second portion of the bar is connected to the mass, the first portion and the second portion of the bar being divided at the pivot point of the bar.

19. A system comprising:
a monopole scatterer coupled to a first side of a structure at a first location; and
a dipole scatterer coupled to a second side of the structure at a second location, wherein the first location at least partially overlaps the second location; and
wherein at least one of the monopole scatterer and the dipole scatterer includes a lever.

20. The system of claim 19, wherein the monopole scatterer and the dipole scatterer have substantially similar resonant frequencies.
